(19) United States
(12) Patent Application Publication
(10) Pub. No.: US 2024/0001171 A1
(43) Pub. Date: Jan. 4, 2024

(54) COATED WOVEN FABRIC FOR PROTECTIVE CLOTHING

(71) Applicant: Nina RYBCHAK, Hilversum (NL)

(72) Inventor: Nina RYBCHAK, Hilversum (NL)

(21) Appl. No.: 18/038,272

(22) PCT Filed: Nov. 30, 2021
(86) PCT No.: PCT/EP2021/083611

§ 371 Date: May 23, 2023

(30) Foreign Application Priority Data
Nov. 30, 2020 (EP) 20210610.0

(51) Int. Cl. A62B 17/00; D03D 15/283; D06N 3/00; D06N 3/04; D06N 3/14; D06M 15/256; D03D 15/41; D03D 1/00; D06B 3/10; B32B 7/14; B32B 5/02; B32B 37/12; B32B 27/32; B32B 27/12; B32B 37/24; B32B 5/26; B32B 37/00

(52) U.S. Cl. CPC A62B 17/003; D03D 15/283; D06N 3/0006; D06N 3/047; D06N 3/14; D06M 15/256; D03D 15/41; D03D 1/0035; D06B 3/10; D06N 3/045; B32B 7/14; B32B 5/024; B32B 37/1292; B32B 27/322; B32B 27/12; B32B 37/24; B32B 5/022; B32B 5/275; B32B 37/0038; D10B 2331/021; D06M 2200/30; D06N 2209/067; D10B 2401/063; D10B 2501/04; A41D 2400/00; A41D 2500/20; A41D 2500/30; B32B 2305/188; B32B 2437/00; B32B 2571/00; B32B 2260/021; B32B 2260/046; B32B 2255/26; B32B 2255/10; B32B 2327/18; B32B 2307/3065; B32B 2262/0269; B32B 2037/243; B32B 2307/718; B32B 2307/54; B32B 2250/20; B32B 2255/02; B32B 2255/28

(57) ABSTRACT

A coated woven fabric including an impregnated woven structure having a woven structure of plain or twill woven yarns of twisted aramid fibers, wherein the impregnated woven structure is impregnated with an organofluorine compound and the fibers have a linear density of 350 to 1000 dtex and a coating layer provided on at least one side of the impregnated woven structure.

### FIELD OF THE INVENTION

The present invention relates to a woven fabric and a protective clothing comprising the woven fabric, in particular a firefighter protective clothing.

### BACKGROUND OF THE INVENTION

In known protective clothing for firefighters, the outermost layer consists of a waterproof membrane layer provided with a fire resistant textile layer. While the known firefighter protective clothing is satisfactory in some situations, there is still a need in the industry for a firefighter protective clothing which allows the firefighters to work more efficiently and safely.

EN 469 is a standard for protective clothing for firefighters which sets out performance requirements for protective clothing for firefighters. In accordance with EN 469 there are four major performance levels which shall be shown on the pictogram attached to the garment. These levels include heat protection (heat Xf1 or Xf2 and radiation Xr1 or Xr2), resistance to water penetration (Y1 or Y2) and water vapour resistance (Z1 or Z2), wherein the second value corresponds to a higher level of performance.

The water vapour resistance (Ret) is tested in accordance with EN ISO 11092 and one of the following performance grades shall be achieved: Z1>30 m² Pa/W, but not exceeding 45 m² Pa/W, Z2≤30 m² Pa/W.

### SUMMARY OF THE INVENTION

It is an objective of the invention to provide a material which can be used as the outermost layer of a protective clothing having a combination of desirable properties which allows the firefighters to work more efficiently and safely. It is a further objective of the invention to provide a material with sufficient water vapor resistance according to EN 469. It is a further objective of the present invention to provide a fire and heat resistant fabric for protective clothing, which has high fire and heat resistant properties as well as a high durability during its life cycle.

Accordingly, the present invention provides a coated woven fabric comprising
an impregnated woven structure comprising a woven structure of plain or twill woven yarns of twisted aramid fibers, wherein the impregnated woven structure is impregnated with an organofluorine compound and the fibers have a linear density of 350 to 1000 dtex and
a coating layer provided on at least one side of the impregnated woven structure.

It has surprisingly been found that the coated woven fabric according to the invention is fire resistant, waterproof and has good mechanical properties while being lightweight.

### DETAILED DESCRIPTION OF THE INVENTION

Impregnated Woven Structure

Yarns

Preferably, the yarns of the twisted aramid fibers have a twisting level Z of 70-150, more preferably 100 to 150. It was found that this results in the desirable mechanical properties of the woven fabric according to the invention.

Preferably, the aramid fibers are para-aramid fibers or meta-aramid fibers, more preferably para-aramid fibers, even more preferably para-aramid fibers of polyparaphenylene terephthalamide (commercially available as Kevlar (trademark) from du Pont Co.) and/or copolyparaphenylene-3,4′-oxydiphenylene terephthalamide (commercially available as Technora (trademark) from Teijin Co.).

The linear density of 350 to 1000 dtex of the aramid fibers leads to the fabric according to the invention which has a combination of a small weight and good tensile/tear strength as well as high resistance to multiple bending.

Preferably, the linear density of the fibers is 370 to 900 dtex, preferably 380 to 800 dtex, more preferably 390 to 700 dtex, more preferably 400 to 600 dtex, more preferably 410 to 500 dtex, more preferably 420 to 450 dtex.

The weaving of the yarns is performed by plain or twill weaving. It was found that a woven structure made by other types of weaving, becomes heavier for achieving the same level of water resistance. Plain weaving is especially preferred, as the woven structures made by plain weaving can be the lightest while achieving the same level of water resistance. The woven structure consists of warp yarns and weft yarns. The weight ratio between the warp yarns and the weft yarns may e.g. be 3:7 to 7:3.

Preferably, the impregnated woven structure comprises twisted multifilament yarns and twisted staple yarns, with a proportion of multifilament yarn mass in the warp from 13.5 to 100% of the total mass of multifilament yarns and staple yarns on the warp, and with a proportion of multifilament yarn mass in the weft from 15.4 to 52.3% of the total weight of multifilament yarns and staple yarns on the weft.

In this case, preferably the number of warp yarns per 10 cm is 165-208, and the number of weft yarns per 10 cm is 134-163. Preferably the surface density of the impregnated woven structure is between 130-165 g/m².

Alternatively, the impregnated woven structure is made from twisted staple yarns. In this case, preferably, the number of warp yarns per 10 cm is preferably 211-225, and the number of weft yarns per 10 cm is preferably 228-266. Preferably the surface density of the impregnated woven structure is 195-210 g/m².

When the impregnated woven structure is made from twisted staple yarns, it is furthermore preferable that:
the twisting level of multifilament yarns is 70-120 per 1 m;
the twisted yarn consists of two twisted threads, each of which has a twisting level of 950-1100 twists per 1 m and the number of joint twists per 1 m is 350-400;
the surface density of the fabric is 330-420 g/m², more preferably 350-400 g/m² as measured according to GOST 17073.

The number of warp yarns for plain woven fabric is preferably 165-208 per 10 cm, for the twill woven fabric preferably 211-225 yarns per 10 cm. The number of weft threads for plain woven fabric is preferably 134-163 per 10 cm, and for twill woven fabric preferably 228-266 yarns per 10 cm.

Impregnation

The impregnated woven structure according to the invention may be made by weaving the yarns to obtain a woven structure followed by impregnating the woven structure with the organofluorine compound. The impregnation results in a structure by which a better contact is ensured between the impregnated woven structure and the coating layer comprising the polyurethane.

The impregnation may be performed by immersing the woven structure in an aqueous impregnation solution comprising the organofluorine compound and optional components and curing the solution by which the organofluorine compound and the optional components are fixed on the woven structure. The immersion may be performed in one step or two or more steps.

Organofluorine Compound

The organofluorine compound gives the impregnated woven structure water-oil repellent properties as well as shaping properties. It further prevents the composition of the coating layer from penetrating to the opposite side of the coated side.

The organofluorine compound may be a polymer comprising repeat units of a fluorine-containing vinyl monomer. The polymer may be a homopolymer of one type of the fluorine-containing vinyl monomer or a copolymer of two or more types of the fluorine-containing vinyl monomer.

By the term “fluorine-containing vinyl monomer” is meant a compound having at least one polymerizable carbon-to-carbon double bond and at least one hydrogen atom substituted with fluorine atom in the molecule.

For example, the fluorine-containing vinyl monomer may be selected from monomers represented by the following general formula:

CF₂═CF—(O)ₗ [symbol] (CF₂)ₘ—(CFX)ₙ—(O)ₚ [symbol] ᵣ(CFX′)_{q}—Y

wherein l and p are 0 or 1, m, n, r and q stand for an integer of from 0 to 4, X and X′ stand for F, H, Cl or —CF₃, and Y stands for —SO₂-A (in which A stands for OM (M is H⁺ or a metal ion), F, Cl or Br),

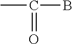

(in which B stands for A or OR (R is an alkyl group such as methyl or ethyl)), —CN, —CF₃ or —CF═CF₂.

The polymer may comprise repeat units of further comonomers. Preferably, the amount of the repeat units of the fluorine-containing vinyl monomer with respect to the polymer is at least 50 wt. %, at least 70 wt. %, at least 90 wt. % or at least 95 wt. %.

Preferably, the amount of the organofluorine compound with respect to the woven structure is 0.05 to 0.20 g/m², more preferably 0.09 to 0.15 g/m². Herein, when an amount of a compound is mentioned, it refers to the weight of the compound in relation to 1 m² of the non-impregnated woven structure.

The organofluorine compound may be applied as an aqueous composition comprising the organofluorine compound e.g. in an amount of 10 to 30 wt. %.

Other components of impregnating solution

The impregnated woven structure may further comprise a crosslinking agent and/or a flame retardant.

The crosslinking agent may e.g. be a polyisocyanate. By the use of the crosslinking agent, water-oil-dirt-repellent properties and resistance to water column pressure are enhanced.

Preferably, the amount of the crosslinking agent with respect to the woven structure is 0.10 to 0.25 g/m².

Preferably, the weight ratio of the crosslinking agent to the organofluorine compound in the impregnated woven structure is 0.9 to 2.5, for example 1.0 to 2.0.

Preferably, the flame retardant comprises ammonium polyphosphate, more preferably ammonium polyphosphate with crystalline phase 1 having less than 1000 repeat units. The flame retardant ensures that the impregnated woven structure is flame-retardant.

Preferably, the amount of the flame retardant with respect to the woven structure is 1.5 to 3.0 g/m².

Preferably, the weight ratio of the flame retardant to the organofluorine compound in the impregnated woven structure is 10 to 35, for example 10 to 30.

Preferably, the total amount of the organofluorine compound, the crosslinking agent and the flame retardant with respect to the woven structure is 1.0 to 5.0 g/m², preferably 2.0 to 3.5 g/m².

Coating Layer

The coated woven fabric according to the invention comprises a coating layer provided on at least one side of the impregnated woven structure. The coating layer gives the desired high water resistance to the coated woven fabric according to the invention as well as hold the woven yarns together to maintain the shape and properties of the coated woven fabric to allow its use in a protective clothing.

Preferably, the coating layer comprises a polyurethane (PU), polytetrafluoropolyethylene (PTFE), or polyethylene (PE).

Coating Layer—Applied as Solution

The coated woven fabric according to the invention may be obtained by applying a solution of the coating material, for example by applying an aqueous solution comprising a polyurethane and optional components on one or both sides of the impregnated woven structure and curing the solution, by which the polyurethane and the optional components form the coating fixed to the impregnated woven structure. The application of the polyurethane and the optional components may be performed in one step or two or more steps.

A coated woven fabric obtained according to the abovementioned method is substantially lighter than a two-layer structure of a waterproof membrane layer provided with a fire resistant textile layer. This allows such a coated woven fabric to be used for making a protective clothing such as a firefighter protective clothing which is lightweight while having desirable properties. The small weight of a protective clothing allows the wearer of the protective clothing to work efficiently.

Polyurethane

Preferably, the polyurethane is an aromatic polyurethane.

Preferably, the amount of the polyurethane is 1 to 10 g/m², preferably 3 to 6 g/m², with respect to the woven structure.

The polyurethane may be applied as an aqueous composition comprising the organofluorine compound e.g. in an amount of 20 to 40 wt. %.

Other Components of Coating Solution

The coating layer may further comprise at least one of a styrene-acrylic copolymer, a defoaming agent, a crosslinking agent, a flame retardant and a thickener.

The styrene-acrylic copolymer enhances the water resistance.

Preferably, the amount of the styrene-acrylic copolymer is 1 to 10 g/m², preferably 3 to 8 g/m², with respect to the woven structure.

Preferably, the weight ratio of the styrene-acrylic copolymer to the polyurethane in the coating layer is 0.5 to 2.5, preferably 0.6 to 2.2.

Preferably, the defoaming agent is an oil-silicon emulsion of a water soluble amphiphilic copolymer.

Preferably, the amount of the defoaming agent is 0.10 to 0.25 g/m² with respect to the woven structure.

Preferably, the weight ratio of the defoaming agent to the polyurethane in the coating layer is 0.01 to 0.08, preferably 0.02 to 0.07.

The crosslinking agent may e.g. be a polyisocyanate. By the use of the crosslinking agent, water-oil-dirt-repellent properties and resistance to water column pressure are enhanced.

Preferably, the amount of the crosslinking agent is 1.0 to 2.5 g/m² with respect to the woven structure.

Preferably, the weight ratio of the crosslinking agent to the polyurethane in the coating layer is 0.1 to 0.8, preferably 0.2 to 0.7.

Preferably, the flame retardant comprises antimony trioxide and/or ammonium polyphosphate.

When the flame retardant comprises antimony trioxide, the flame retardant preferably comprises antimony trioxide and a halogen source. This is advantageous in that it gives a fire-resistant coating without soapiness.

Preferably, the total amount of the antimony trioxide and the halogen source is 3.0 to 7.0 g/m² with respect to the woven structure.

Preferably, the weight ratio of the total amount of the antimony trioxide and the halogen source to the polyurethane in the coating layer is 0.5 to 2.0, preferably 0.6 to 1.7.

When the flame retardant comprises ammonium polyphosphate, the ammonium polyphosphate is preferably a polymer with more than 1000 repeat units and has crystalline phase 2. This gives a fire-resistant coating with specified waterproof properties.

Preferably, the amount of ammonium polyphosphate is 10 to 20 g/m² with respect to the woven structure.

Preferably, the weight ratio of ammonium polyphosphate to the polyurethane in the coating layer is 1.5 to 7.0, preferably 2.0 to 6.0.

Preferably, the thickener is an acrylic polymer. This improves the coating process.

Preferably, the amount of the thickener is 0.10 to 0.20 g/m² with respect to the woven structure.

Preferably, the weight ratio of the thickener to the polyurethane in the coating layer is 0.01 to 0.1.

Coating Layer—Membrane

Alternatively, the coating layer may be a membrane. Preferably, the membrane is a microporous, flexible and highly breathable single or double layer with moisture barrier properties. Such a moisture barrier membrane may be an important protective layer of fire protective clothing. These membranes allow for sweat to pass through to the outer fabrics, to enable easier regulation of body temperature, allowing users to stay more comfortable for longer. Preferably the membrane comprises polytetrafluoroethylene (PTFE), polyurethane (PU) or polyethylene (PE).

Polytetrafluoroethylene, or PTFE, is a synthetic material which can be expanded to form a porous membrane that can be laminated to fabric to ensure its waterproof, windproof and heat resistant properties. Preferably the PTFE is expanded PTFE (ePTFE). The surface of PTFE membranes is hydrophobic.

When the membrane comprises PU, preferably the PU is flame retardant PU (PUFR). When the membrane comprises PE, preferably the PE is flame retardant PE (PEFR). Especially preferred is a membrane comprising both PTFE and PU, preferably ePTFE and PUFR (i.e. a bicomponent PTFE/PU, notably an ePTFE/PUFR membrane). Such bicomponent membranes consist of two layers and provide the best results when used in the coated woven fabric. Coated woven fabrics with these membranes comprise in order, and attached to each next layer: the impregnated woven structure, the PTFE membrane, and the PU membrane.

It was furthermore found out that the vapour resistance increases, and body moisture is significantly better transported in case the outer layer is laminated with membrane instead of coating with PU based solution.

Application of Membrane

The membrane may be applied by laminating the woven fabric on one side (preferably the inner side of the fabric, i.e. the side which will face the body of the person wearing the fabric) with the membrane with a glue with dot lamination. Preferably the glue is a hot melt, such as a reactive PU hot melt.

Proportion of Elements

Preferably, the amount of the woven structure with respect to the impregnated woven structure is 95 to 99.5 wt. %, preferably 97 to 99.0 wt. %.

Preferably, the amount of the woven structure with respect to the coated woven fabric is 60 to 90 wt. %, preferably 65 to 85 wt. %.

Preferably, when the coating is applied as a solution, the amount of the coating layer with respect to the coated woven fabric is 10 to 40 wt. %, preferably 15 to 35 wt. %.

Preferably, when the coating is a membrane, the membrane is present at a weight percentage of 20-50%, preferably between 30 and 40% of the weight of the coated woven fabric.

Properties of Coated Woven Fabric

Preferably, the coated woven fabric according to the invention has a density of 150 to 230 g/m², preferably 170 to 220 g/m², more preferably 175 to 210 g/m², as measured according to GOST 17073.

Preferably, the coated woven fabric according to the invention has a tensile strength of at least 2440 N measured in the warp direction according to GOST 17316 at 23° C.

Preferably, the coated woven fabric according to the invention has a tensile strength of at least 2440 N measured in the weft direction according to GOST 17316 at 23° C.

Preferably, the coated woven fabric according to the invention has a tensile strength of at least 2440 N measured in the warp direction according to GOST 17316 at 300° C.

Preferably, the coated woven fabric according to the invention has a tensile strength of at least 2440 N measured in the weft direction according to GOST 17316 at 300° C.

Preferably, the coated woven fabric according to the invention has a tear strength of at least 300 N measured in the warp direction according to GOST 17074 at 23° C. Preferably, the coated woven fabric according to the invention has a tear strength of at least 300 N measured in the weft direction according to GOST 17074 at 23° C.

Preferably, the coated woven fabric according to the invention has a resistance to multiple bending measured according to GOST 8978 of at least 100 kilocycles.

Preferably, the coated woven fabric according to the invention has an open flame resistance according to GOST P53264 of 0 second, i.e. it has 0 second combustion after exposure to open flame for 15 seconds.

Preferably, the coated woven fabric according to the invention has an oxygen index measured according to GOST12.1.044 of 15 to 50%.

Preferably, the coated woven fabric according to the invention has a water resistance according to GOST P 53264-2009 of 1000 mm of water column applied as a static load for 1 minute.

Preferably, the coated woven fabric has a water vapour resistance with a Ret value of less than 30 m 2 Pa/W as measured according to EN ISO 11092. To determine the Ret value, the thermal water vapor resistance is determined under steady state conditions. More preferably the Ret value of the coated woven fabric is less than 20 m² Pa/W as measured according to EN ISO 11092.

The invention further provides a process for making the coated woven fabric according to the invention, comprising the steps of:
i) plain weaving the yarns to obtain the woven structure,
ii) immersing the woven structure in an aqueous solution comprising the organofluorine compound,
iii) curing the aqueous solution of step ii) to obtain the impregnated woven structure,
iv) applying a coating layer on at least one side of the impregnated woven structure.

In an embodiment, step iv) comprises
a) applying an aqueous composition comprising the polyurethane on one or both sides of the impregnated woven structure and
b) curing the aqueous solution of step a) to obtain the coating layer provided on at least one side of the impregnated woven structure

Alternatively, step iv) comprises laminating a coating layer on at least one side of the impregnated woven structure with a glue by dot lamination. Preferably, the coating layer is a porous membrane, more preferably an expanded polytetrafluoroethylene membrane, most preferably an expanded polytetrafluoroethylene membrane comprising a polyurethane coating layer on one side of the membrane, and the membrane is applied on the impregnated woven structure with the polyurethane coating layer facing away from the impregnated woven structure.

In this way, a structure of 3 layers is formed, comprising in order: the impregnated woven structure, the membrane, the polyurethane coating layer.

Protective Clothing

The present invention further relates to a protective clothing comprising the coated woven fabric according to the invention. Preferably, the protective clothing is a firefighter protective clothing.

Preferably, the protective clothing according to the invention comprises, in this order,
a) an outer layer made of the coated woven fabric according to the invention,
b) an intermediate layer made of a non-woven fabric made of meta aramid fibers and
c) an inner lining layer made of a woven fabric made of staple meta aramid fibers, wherein the intermediate layer faces the coating layer of the outer layer.

During use, the outer layer is to be farthest from the user among a)-c). Preferably, the inner lining layer is to be in contact with the user and provides comfort to the user.

Preferably, the outer layer and the intermediate layer are partly attached to each other, i.e. attached to each other such that there are parts that are adhered to each other and parts that are not adhered to each other. This can be achieved e.g. by adhering only the edges of the outer layer and the intermediate layer or by adhering the outer layer and the intermediate layer intermittently. The parts not adhered to each other have air in-between, which works as a heat insulating agent.

In some preferred embodiments, the protective clothing according to the invention consists of the layers a), b) and c).

In some preferred embodiments, the protective clothing according to the invention further comprises between the layers b) and c) a layer made of the woven fabric according to the invention. In this additional layer, the woven fabric according to the invention may be of the same type or different type from the woven fabric according to the invention in the outer layer. When present, the additional layer is provided such that the intermediate layer faces the coating layer of said additional layer.

Process for Making Protective Clothing

The invention further relates to a process for making the protective clothing according to the invention, comprising the steps of attaching, in this order, the outer layer, the intermediate layer and the inner lining layer.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### Examples

Fibers of polyparaphenylene terephthalamide having a linear density of as shown in Table 2 were twisted to obtain yarns having a twisting level Z of 120. The yarns were subjected to plain weaving to obtain a woven structure. The woven structure was impregnated with an aqueous impregnating solution and subsequently cured. Subsequently an aqueous coating solution was applied on one side of the impregnated woven structure and cured to obtain a coated woven fabric.

The compositions of the impregnating solution and the coating solution used for making the coated woven fabric of Ex 2 are shown in Table 1. The amounts are indicated as weight concentrations (g/m²) with respect to the woven structure. The components and their proportions of the impregnating solution and the coating solution used for making the coated woven fabric of Ex 1 and CEx 3 were identical to those used for making the coated woven fabric of Ex 2.

TABLE 1
(amounts in g/m²)

| | impregnating | coating |
|---|---|---|
| | solution | solution |
| Water dispersion of aromatic polyurethane, | | 11.80-16.85 |
| dry content 28-35 wt. % (Aquapol 10) | | (3.30-5.90)* |
| Water dispersion of styrene-acrylic | | 10.55-15.50 |
| copolymer, dry content 38-45 wt. % | | (4.01-7.00)* |
| (Lacroten) | | |
| Defoaming agent (Entschaumer N) | | 0.14-0.20 |
| Polyisocyanate crosslinking agent | 0.14-0.20 | 1.4-2.0 |
| (Igkaguard BLO (FF)) | | |
| Flame retardant: | | 5.8-8.3 |
| Water dispersion of antimony trioxide and | | (3.77-5.48)* |
| halogen source, dry content 63.0-66.0 wt. % | | |
| (FLACAVON FH9004/123L) | | |
| Flame retardant: | | 13-18.6 |
| Branched ammonium polyphosphate with | | |
| high degree of polymerization (n > 1000) | | |
| with crystalline phase 2 (Antipiren APP501) | | |
| Acrylic thickener (Rheovis HS 1212) | | 0.11-0.15 |
| Flame retardant: | 1.9-2.8 | |
| Low polymerization ammonium | | |
| polyphosphate with crystalline | | |
| phase 1 (Antipiren APP-3) | | |
| Aqueous composition of polymer based on | 0.6-0.85 | |
| fluorine-containing vinyl monomers, dry | (0.10-0.14)* | |
| content 16.5 wt. % | | |

*amount of dry content

Various properties of the coated woven fabric were measured and are shown in Table 2.

TABLE 2

| | density | density (g/m²) | density (g/m²) | | | | | | | | |
|---|---|---|---|---|---|---|---|---|---|---|---|
| | (dtex) of | of warp/weft | of coated | Tensile (breaking) strength (N) | | | | Tear strength (N) | | | |
| | warp/weft | in coated | woven | 23° C. | | 300° C. | | 23° C. | | 300° C. | |
| | yarns | woven fabric | fabric | warp | weft | warp | weft | warp | weft | warp | weft |
| CEx 1 | 330/440 | 55/62 | 170 | >2440 | >2440 | 2350 | 1680 | 245 | 230 | 143 | 158 |
| Ex 2 | 440/440 | 78/61 | 175 | >2440 | >2440 | >2440 | >2440 | 420 | 430 | 235 | 278 |
| CEX 3 | 440/1100 | 74/116 | 302 | >2440 | >2440 | >2440 | >2440 | 662 | 658 | 302 | 312 |

The density of the coated woven fabric was measured according to GOST 17073.

The tensile strength of the coated woven fabric in the warp direction and the weft direction was measured according to GOST 17316 at 23° C. and 300° C.

The tear strength of the coated woven fabric was measured in the warp direction and the weft direction according to GOST 17074 at 23° C. and 300° C.

The resistance to multiple bending of the coated woven fabric was measured according to GOST 8978. It was 90-100 Kcycles for CEx 1 while it was more than 100 Kcycles for Ex 2 and CEx 3.

The open flame resistance of the coated woven fabric was measured according to GOST P53264. For CEx 1, Ex 2 and CEx 3, it was 0 second combustion after exposure to open flame for 15 seconds.

The oxygen index the coated woven fabric was measured according to GOST12.1.044. For CEx 1, Ex 2 and CEx 3, the oxygen index was 31%.

The coated woven fabric of CEx 1, Ex 2 and CEx 3 was determined to have the required water resistance determined according to GOST P 53264-2009 of 1000 mm of water column applied as a static load during 1 minute.

It can accordingly be understood that the fabric according to the invention has the combination of a lower weight and superior mechanical properties compared to the fabric not according to the invention.

Furthermore, the Ret index of coated woven fabrics was determined.

The coated woven fabric of Ex 2 had a Ret index value of 43-53 m2 Pa/W.

The impregnated woven structure used in Ex 2 was also prepared as a woven fabric laminated with an ePTFE/PUFR bicomponent membrane as a coating (i.e. instead of the solution applied coating) (Ex2b). This coated woven fabric had a Ret index value of below 30 m² Pa/W, within the range 15-30 m² Pa/W.

The impregnated woven structure used in Ex 2 was also prepared as a woven fabric laminated with an ePTFE/PUFR bicomponent membrane, the membrane comprising a solution applied PU coating (Ex 2c). A Ret index of 5-10, such as between 6-8 m² Pa/W was achieved.

The coated woven fabric of Ex 2c has superior water vapour resistance and retains supreme heat resistance properties along with a low weight of under 500 g/m².

Table 3 provides a comparison of water vapor permeability of Ex 2 and Ex 2b.

TABLE 3

| | | 100% para-aramid | |
|---|---|---|---|
| | | filament fibers | 100% para-aramid |
| | | laminated with | filament fibers |
| Property | Unit | membrane (Ex 2b) | PU coated (Ex 2) |
| Vapour | Mg/cm2 | 8.4 | 2.2 |
| permeability | hour | | |
| (GOST 22900 | | | |

Measured according to GOST 22900, the vapour permeability of 100% para-aramid filament fibers laminated with membrane is higher which proves better breathability.

Multiple bending according to GOST 8978 was performed for different fabrics. Table 4 shows a comparison of fabrics laminated with a membrane, wherein the fabric was made of multifilament yarns, mixed multifilament and staple yarns and staple yarns.

TABLE 4

| | | 100% para- | 60% para- | |
|---|---|---|---|---|
| | | aramid | aramid | 100% staple |
| | | multifilament | multifilament + | fiber yarns |
| | | fibers | 40% staple fiber | laminated |
| | | laminated with | yarns laminated | with ePTFE + |
| | | ePTFE + PUFR | with ePTFE + | PUFR |
| Property | Unit | membrane | PUFR membrane | membrane |
| Multiple bending | kilocycle | 100-110 | 110-150 | >150 |
| Measured according | | | | |
| to GOST 8978 | | | | |

The resistance to multiple bending is increased by adding staple fiber yarns to multifilament para-aramid yarns. This property is one of the most important indicators of fabric durability and long life cycle.

Further tests have been performed with samples wherein the impregnated woven structure was provided with a PTFE membrane, wherein the PTFE membrane was coated with PU.

TABLE 5

| | | Warp: black para- | | |
|---|---|---|---|---|
| | | aramid | | |
| | | multifilaments + | Warp: 100% | Warp: |
| | | yellow para-aramid | black para- | 21.7% para- |
| | | filaments | aramid | aramid |
| | | Weft: black para- | multifilaments | filament |
| | | aramid | Weft: 100% black | Weft: 78.3% |
| | | multifilaments + | para-aramid | aramid |
| | | yellow para-aramid | multifilaments + | staple yarn + |
| | Property | filaments + PU + PTFE | PU + PTFE | PU + PTFE |
| 1 | Weight | 188 | 186 | 183 |
| | (g/m²) of coated | | | |
| | woven fabric | | | |
| 2 | density (dtex) of | 440/440 | 440/440 | 440/450 + |
| | warp/weft yarns | | | 440 |
| 3 | Tensile (breaking) | | | |
| | strength (N) | | | |
| | Warp | >2440 | >2440 | 2440 |
| | weft | >2440 | >2440 | 1420 |
| 4 | Tear strength (N) | | | |
| | warp | 510 | 610 | 340 |
| | weft | 580 | 580 | 250 |
| | after exposure to | | | |
| | ambient | | | |
| | temperature up to | | | |
| | 300° C. for 300 | | | |
| | seconds | | | |
| | warp | 505 | 405 | 205 |
| | weft | 510 | 430 | 225 |

The invention furthermore relates to the following clauses:
1. A coated woven fabric comprising
an impregnated woven structure comprising a woven structure of plain woven yarns of twisted para-aramid fibers, wherein the impregnated woven structure is impregnated with an organofluorine compound and the fibers have a linear density of 350 to 1000 dtex and
a coating layer comprising a polyurethane provided on at least one side of the impregnated woven structure.
2. The coated woven fabric according to any one of the preceding clauses, wherein the para-aramid fibers are fibers of polyparaphenylene terephthalamide polyparaphenylene terephthalamide and/or a copolyparaphenylene-3,4′-oxydiphenylene terephthalamide.
3. The coated woven fabric according to any one of the preceding clauses, wherein the yarns of the twisted para-aramid fibers have a twisting level Z of 100 to 150.
4. The coated woven fabric according to any one of the preceding clauses, wherein the linear density of the fibers is 370 to 900 dtex, preferably 380 to 800 dtex, more preferably 390 to 700 dtex, more preferably 400 to 600 dtex, more preferably 410 to 500 dtex, more preferably 420 to 450 dtex.
5. The coated woven fabric according to any one of the preceding clauses, wherein the organofluorine compound is a polymer comprising repeat units of a fluorine-containing vinyl monomer, preferably wherein the amount of the organofluorine compound with respect to the woven structure is 0.05 to 0.20 g/m², more preferably 0.09 to 0.15 g/m².
6. The coated woven fabric according to any one of the preceding clauses, wherein the impregnated woven structure further comprises a crosslinking agent and/or a flame retardant.
7. The coated woven fabric according to any one of the preceding clauses, wherein the polyurethane is an aromatic polyurethane, preferably wherein the amount of the polyurethane with respect to the woven structure is 1 to 10 g/m², preferably 2 to 7 g/m².
8. The coated woven fabric according to any one of the preceding clauses, wherein the coating layer further comprises at least one of a styrene-acrylic copolymer, a defoaming agent, a crosslinking agent, a flame retardant and a thickener.
9. The coated woven fabric according to any one of the preceding clauses, wherein the coated woven fabric has a density of 100 to 200 g/m², preferably 170 to 180 g/m², as measured according to GOST 17073, and preferably at least one, more preferably all, of:
a tensile strength of at least 2440 N measured in the warp direction according to GOST 17316 at 23° C.,
a tensile strength of at least 2440 N measured in the weft direction according to GOST 17316 at 23° C.,
a tensile strength of at least 2440 N measured in the warp direction according to GOST 17316 at 300° C.,
a tensile strength of at least 2440 N measured in the weft direction according to GOST 17316 at 300° C.,
a tear strength of at least 300 N measured in the warp direction according to GOST 17074 at 23° C.,
a tear strength of at least 300 N measured in the weft direction according to GOST 17074 at 23° C.,
a resistance to multiple bending measured according to GOST 8978 of at least 100 kilocycles,
an open flame resistance according to GOST P53264 of 0 second,
an oxygen index measured according to GOST12.1.044 of 15 to 50% and
the required water resistance according to GOST P 53264-2009 of 1000 mm of water column applied as a static load for 1 minute.
10. A process for making the coated woven fabric according to any one of the preceding clauses, comprising the steps of:
i) weaving the yarns to obtain the woven structure,
ii) immersing the woven structure in an aqueous solution comprising the organofluorine compound,
iii) curing the aqueous solution of step ii) to obtain the impregnated woven structure,
iv) applying an aqueous composition comprising the polyurethane on one or both sides of the impregnated woven structure and
v) curing the aqueous solution of step iv) to obtain the coating layer provided on at least one side of the impregnated woven structure.
11. A protective clothing comprising the woven fabric according to any one of clauses 1 to 9.
12. The protective clothing according to clause 11 comprising or consisting of, in this order,
a) an outer layer made of the coated woven fabric according to the invention,
b) an intermediate layer made of a non-woven fabric made of meta aramid fibers and
c) an inner lining layer made of a woven fabric made of staple meta aramid fibers, wherein the intermediate layer faces the coating layer of the outer layer.
13. The protective clothing according to clause 12, wherein the outer layer and the intermediate layer are partly attached to each other.
14. The protective clothing according to clause 12 or 13, wherein the protective clothing is a firefighter protective clothing.
15. Use of the coated woven fabric according to any one of clauses 1 to 9 for making a firefighter protective clothing.

What is claimed is:

1. A coated woven fabric, comprising:
an impregnated woven structure comprising a woven structure of plain or twill woven yarns of twisted aramid fibers, wherein the impregnated woven structure is impregnated with an organofluorine compound and the fibers have a linear density of 350 to 1000 dtex and
a coating layer provided on at least one side of the impregnated woven structure.

2. The coated woven fabric according to claim 1, wherein the coating layer comprises a polyurethane (PU), polytetrafluoroethylene (PTFE), or polyethylene (PE).

3. The coated woven fabric according to claim 1, wherein the coating layer comprises a polyurethane (PU).

4. The coated woven fabric according to claim 1, wherein the coating layer is a membrane, preferably wherein the membrane comprises expanded polytetrafluoroethylene (e-PTFE).

5. The coated woven fabric according to claim 4, wherein the membrane comprises a coating layer comprising a polyurethane, on the side opposing the impregnated woven structure.

6. The coated woven fabric according to claim 1, wherein the impregnated woven structure comprises twisted staple yarns.

7. The coated woven fabric according to claim 1, wherein the impregnated woven structure comprises twisted multifilament yarns and twisted staple yarns, with a proportion of multifilament yarn mass in the warp from 13.5 to 100% of the total mass of multifilament yarns and staple yarns on the warp, and with a proportion of multifilament yarn mass in the weft from 15.4 to 52.3% of the total weight of multifilament yarns and staple yarns on the weft.

8. The coated woven fabric according to claim 1, wherein the impregnated woven structure is made from twisted staple yarns.

9. The coated woven fabric according to claim 1, wherein the aramid fibers are para-aramid fibers, preferably para-aramid fibers of polyparaphenylene terephthalamide polyparaphenylene terephthalamide and/or a copolyparaphenylene-3,4′-oxydiphenylene terephthalamide.

10. The coated woven fabric according to claim 1, wherein the yarns of the twisted para-aramid fibers have a twisting level Z of 70-150, preferably of 100 to 150.

11. The coated woven fabric according to claim 1, wherein a linear density of the fibers is 370 to 900 dtex, preferably 380 to 800 dtex, more preferably 390 to 700 dtex, more preferably 400 to 600 dtex, more preferably 410 to 500 dtex, more preferably 420 to 450 dtex.

12. The coated woven fabric according to claim 1, wherein the organofluorine compound is a polymer comprising repeat units of a fluorine-containing vinyl monomer, preferably wherein the amount of the organofluorine compound with respect to the woven structure is 0.05 to 0.20 g/m², more preferably 0.09 to 0.15 g/m².

13. The coated woven fabric according to claim 1, wherein the impregnated woven structure further comprises a crosslinking agent and/or a flame retardant.

14. The coated woven fabric according to claim 2, wherein the polyurethane is an aromatic polyurethane, preferably wherein the amount of the polyurethane with respect to the woven structure is 1 to 10 g/m², preferably 2 to 7 g/m².

15. The coated woven fabric according to claim 1, wherein the coating layer further comprises at least one of a styrene-acrylic copolymer, a defoaming agent, a crosslinking agent, a flame retardant and a thickener.

16. The coated woven fabric according to claim 1, wherein the coated woven fabric has a density of 100 to 200 g/m², preferably 170 to 180 g/m², as measured according to GOST 17073, and preferably at least one, more preferably all, of:
a tensile strength of at least 2440 N measured in the warp direction according to GOST 17316 at 23° C.,
a tensile strength of at least 2440 N measured in the weft direction according to GOST 17316 at 23° C.,
a tensile strength of at least 2440 N measured in the warp direction according to GOST 17316 at 300° C.,
a tensile strength of at least 2440 N measured in the weft direction according to GOST 17316 at 300° C.,
a tear strength of at least 300 N measured in the warp direction according to GOST 17074 at 23° C.,
a tear strength of at least 300 N measured in the weft direction according to GOST 17074 at 23° C.,
a resistance to multiple bending measured according to GOST 8978 of at least 100 kilocycles,
an open flame resistance according to GOST P53264 of 0 second,
an oxygen index measured according to GOST12.1.044 of 15 to 50% and
the required water resistance according to GOST P 53264-2009 of 1000 mm of water column applied as a static load for 1 minute.

17. A process for making the coated woven fabric according to claim 1, comprising the steps of:
i) weaving the yarns to obtain the woven structure,
ii) immersing the woven structure in an aqueous solution comprising the organofluorine compound,
iii) curing the aqueous solution of step ii) to obtain the impregnated woven structure,
iv) applying a coating layer on at least one side of the impregnated woven structure.

18. The process according to claim 17, wherein step iv) comprises
applying an aqueous composition comprising the polyurethane on one or both sides of the impregnated woven structure and
curing the aqueous solution of step a) to obtain the coating layer provided on at least one side of the impregnated woven structure

19. The process according to claim 17, wherein step iv) comprises laminating a coating layer on at least one side of the impregnated woven structure with a glue by dot lamination.

20. The process according to claim 19, wherein the coating layer is a porous membrane, more preferably an expanded polytetrafluoroethylene membrane, most preferably an expanded polytetrafluoroethylene membrane comprising a polyurethane coating layer on one side of the membrane, and the membrane is applied on the impregnated woven structure with the polyurethane coating layer facing away from the impregnated woven structure.

21. A protective clothing comprising the woven fabric according to claim 1.

22. The protective clothing according to claim 21 comprising or consisting of, in this order,
a) an outer layer made of the coated woven fabric according to the invention,
b) an intermediate layer made of a non-woven fabric made of meta aramid fibers and
c) an inner lining layer made of a woven fabric made of staple meta aramid fibers, wherein the intermediate layer faces the coating layer of the outer layer.

23. The protective clothing according to claim 22, wherein the outer layer and the intermediate layer are partly attached to each other.

24. The protective clothing according to claim 22, wherein the protective clothing is a firefighter protective clothing.

25. Use of the coated woven fabric according to claim 1 for making a firefighter protective clothing.
